(19) United States
(12) Patent Application Publication
(10) Pub. No.: US 2006/0218845 A1
(43) Pub. Date: Oct. 5, 2006

(54) Fly fishing method and apparatus

(76) Inventor: Patrick E. Moffitt, Califon, NJ (US)

Correspondence Address: Glen M. Diehl;NORTON & DIEHL LLC, Suite 110, 77 Brant Avenue, Clark, NJ, 07066, US

(21) Appl. No.: 11/092,324

(22) Filed: Mar. 29, 2005

(51) Int. Cl. A01K 85/00

(52) U.S. Cl. 43/42.15; 43/43.15

(57) ABSTRACT

A hook-less fly crafted on a core other than a hook is described for attachment to a line at a material distance from a distal circle hook. One or more fly(s) may be attached to a single line at a point above a single circle hook. The separation on the line of hook from fly requires only the fly to enter the fish's mouth. The hook, when a fish takes the fly, is externally located. Striking the rod in response to the fish taking the fly draws the line through the fish's mouth and engages the distally located circle hook into the outer jaw. Hook set offered by the method is diametrically opposed in direction compared to conventional fishing. The method prevents the hook from piercing internal organs and facilitates hook extraction. The method further overcomes the physical limitations imposed on circle hook use by conventional fishing methods. The method promotes the survival of fish following release. The design, construction and means of attachment for the hook-less fly is further described. A line orientation structure can be provided on the hook-less fly. Various line attachment devices are disclosed for the hook-less fly.

### BACKGROUND OF THE INVENTION

The present invention relates to fly-fishing apparatus and methods.

A fundamental precept of fly fishing is a fish must take the fly hook into its mouth to affect capture. A hook entering a fish's mouth has the potential to inflict a severe wound by piercing a vital organ. Additionally, a hook lodged within the mouth cavity can be difficult and time consuming to extract subjecting a fish to undue handling stress. The resulting wound or induced stress greatly increases the odds that a fish following release will not survive.

Circle hooks have been investigated as a means to minimize post release mortality. The C or circle hook when compared to the J-hook has any number of resource related advantages. Chief among these are the circle hooks' propensity to hook in the jaw rather than the mouth cavity. A conventional fly tied to a circle hook can slide along the inside of the mouth and hooks in the jaw a higher percentage of the time when compared to the J-hook. This is due to the 90 degree orientation of the circle hook's point with respect to the hook shank. A fish hooked in the jaw takes less time to unhook and release than a hook set deeper in the mouth. The handling time required to accomplish this task is directly related to the probability of a fish's post-release survival. The J-hook, because of the parallel hook point, has an increased chance of lodging in the tongue, gill arch or throat. The mortality rate of released fish is unacceptably high when a hook pierces the anatomical structures described above. Mortality, while less with a fly tied on a circle hook, is still significant.

Many anadromous fish, such as salmon, are forced to enter rivers that are small and/or shallow during their spawning migration. Certain areas of a river may see concentrations of these large exposed fish. The probability of foul hooking a fish when angling under these conditions is very high for flies tied onto J-hooks. Some less than honest anglers intentionally foul hook these fish with J-hook flies. A fly tied on a circle hook, due to its design as described above, can reduce this risk. The type and size of flies that can be successfully fished, when crafted onto a circle hook, are limited by the circle hook's design and inherent hook setting characteristics.

The circle hook, despite the inherent resource advantages, has not found wide spread favor among recreational angler's for a variety of reasons. Foremost is the caution to the angler that striking with the rod, in response to a fish's take, will prevent a successful hook set. The angler must resist the urge to pull and allow the fish to set the hook as a result of an ever increasing line tautness created by the fish swimming away with the fly. Angler's, when using any hook in the conventional manner, must first have the hook enter the fish's mouth. A fly tied upon a circle hook, to set, must have a gape sufficient to span the width of the jaw to affect capture. The 90 degree orientation of hook point to shank therefore requires exceptionally large circle hooks to be used when compared to a J-hook. The large hook size needed for a fly tied directly to a circle hook limits their use in tying most of the smaller fly patterns needed for trout.

A conventional fly tied directly onto a circle hook must be pulled by the fish into its mouth in order to engage. A steady line tension draws the hook along the center of the mouth until the eye and hook shank pass over the width of the jaw causing the hook to roll and in so doing exposing the point that engages the inside jaw, other internal mouthpart or organ. An angler jerking the rod in response to a fish's take causes a circle hook to pass through the mouth too quickly for efficient hook set. A circle hook must encounter a highly defined edge to rapidly engage. Only the tongue provides such a structure within a fish's mouth and is not a sufficiently probable or desired hook target. Studies show post-release mortalities of 18% for tongue hooked fish and higher for damaged organs. Allowing the fish to set the circle hook also gives the fish increased time to feel the hook and expel the fly prior to the hook engaging. The caution against striking a fish in the traditional manner has been shown to be the single largest reason anglers fail to embrace this hook choice.

A conventional fly tied directly to a hook must have a hook with sufficient gape to avoid the materials used to craft the fly from interfering with the hook set. In conventional fishing the size of the hook is a function of the size of the fly because of this structural imperative. The reduced gape found in circle hooks, caused by the 90 degree hook point to shank orientation, amplifies the need for increased gape width. The large hooks required producing sufficient gape with conventional fly patterns, including J-hooks, kill or maim non-targeted undersized fish that take the fly.

Fly tied circle hooks have been described as very poor at firmly holding a fish once hooked. Anglers are cautioned as a result to play a fish using less press pressure than common for a J hook so as to prevent pulling the hook.

Anglers have been frustrated by the circle hook's inability to efficiently hook fish when dressed as a fly. There are several reasons for these limitations. A dry fly, as an example, tied to a circle hook can have the hackle used in the fly dressing obscure the hook point and greatly decrease the chance for a positive hook-set by allowing the hook to slide completely out of the mouth. Conventional circle hook fishing methods require the fish to set the hook and given that some fish move very little when feeding the fly can be detected as a non food item and expelled before the hook has a chance to engage. The circle hook, given the described limitations, has little more than a limited role in conventional fly fishing.

A need, therefore, exists to decrease the mortality and injury of released and/or non-targeted fish.

### SUMMARY OF THE INVENTION

In one aspect of the present invention, method and apparatus is described for fly fishing that allows a fish to be captured without requiring the fish to take the hook into its mouth. The rigging and hook design characteristics are further described. The invention, in one aspect, describes a new fishing method whereby the direction of hook set is opposite the traditional method. The invention and resulting method resolve the entire fly fishing limitations associated with circle hook use. The invention provides for a fly, and a means to craft and affix same, to a fishing line that can be fished at a material distance from the hook used for capture.

One aspect of the invention describes a fly crafted on a core other than a hook. The hook-less fly, capable of being affixed to a line without knots, is positioned at a material distance from a distally connected hook. Separation of fly and hook on the same line eliminates the need for fly size and hook size to be related and prevents the hook from entering into the mouth.

In a preferred embodiment, the circle hook is barb-less and constructed with a straight eye and bend (non-offset point). A down eye circle hook decreases the available gape for hook set while an up eye design can force the point, when encountering a fish's mouth part, away from the orientation needed for hook set. A circle hook with an off-set bend, such that the hook point is not parallel to the hook shank, radically decreases the resource advantages described above. An off-set circle hook behaves more like a J-hook since the point of the hook is no longer shielded by the hook shank and allows the hook to foul hook a fish.

In accordance with one aspect of the present invention, the invention describes a fly capable of being tied on a core other than a hook. The fly is capable of being attached to a line at a distance from a terminal circle hook. The distance between hook and fly is sufficient to avoid the hook entering a fish's mouth when it takes the hook-less fly. A fish is captured when the angler sensing a bite strikes with the rod causing the line to be drawn through the fish's mouth and ultimately engaging the circle hook into the outer jaw. This direction of hook set, where the hook starts outside of the fish's mouth, is diametrically opposed to that of conventional fishing where the hook must first enter the mouth.

A fish taking a hook-less fly into its mouth finds the hook outside the mouth cavity contrary to conventional fishing methods. A fish is captured by pulling the line through the fish's mouth causing the hook to be drawn into the outside of the jaw. A fish's outer jaw structure, when fishing conventionally, cannot be engaged by the hook. The outer jaw, however provides a more defined edge than is afforded by the interior jaw. The method allows a hook to engage this more defined edge and enables the circle hook to overcome the imposed conventional limitations. Circle hooks, by this method, can be used in very small sizes, can be used with all styles, sizes and fly dressings and can be fished such that the angler can successful strike in response to a fish's take.

A C or circle hook is preferred over the J hook due to the unique method of hook engagement used in conjunction with the hook-less fly(s). A fish taking the fly in the preferred method does not have the hook enter the mouth cavity due to the distance between circle hook and hook-less fly. An angler, sensing a bite, jerks the rod causing the line to be drawn through the fish's mouth causing the attached hook to set in the fish's outer jaw. A J-hook with its point more parallel to the hook shank is able to engage any body part it encounters while being drawn towards the mouth. The J-hook can, as a result, have an unacceptable frequency of foul hooking fish. Foul hooking is defined as the hook setting in a location other than the mouth structure.

The 90-degree orientation of the circle hook's point and shank requires it to encounter an edge like structure to set. This allows the circle hook to slide along the fish's outer body until it encounters the outer jaw. A circle hook designed with an offset point loses the ability to slide along the body and behaves in the manner of a J-hook.

The sharp edge afforded by the fish's outer jaw, when the hook is pulled from the outside towards the mouth, allows the angler to strike in the traditional manner. Basically, the fish's outer jaw area provides a more defined or abrupt edge and as a result is more conducive to setting a circle hook. The circle hook can be pulled in the opposite direction compared to conventional fishing because only the hook-less fly enters inside the fish's mouth due to the separation of hook-less fly and hook when attached to the line. This allows the circle hook to encounter the far more defined edge of the fish's outer jaw, which is otherwise inaccessible to conventional hook sets. This factor expands the range of rod hook setting options available to the angler when using the hook-less fly and most importantly allows the angler to jerk the rod in response to a fish's taking the fly.

A fly tied directly to a circle hook requires a hook size considerably larger than a J-hook due to the decreased gape caused by the 90-degree orientation of point to shank. The gape must be wide enough to fit over the jaw's width in order for a circle hook to set. Circle hooks of size 6 to 2 are called for when trout fishing. The more defined edge of the outer jaw, described above, overcomes this limitation and circle hooks in the smallest size commercially available, size 18, have routinely landed trout in excess of five pounds and as large as thirteen pounds when used in conjunction with the hook-less flies. The circle hook, when using the outside in hooking method, is not challenged to span the width of the jaw in order to set. This allows the opportunity to use small circle hooks minimizing the potential harm to small fish impaled on large size.

The preferred embodiment of the previously described fishing apparatus and methods, the terminal circle hook does not include fly dressing. A bare circle hook overcomes the problems with the material composing the fly from interfering with the hook point. The circle hook should also be barb-less to facilitate a fast extraction from the jaw, following landing, increasing the post-release survival odds.

In accordance with further aspects of the present invention, one or more hook-less fly(s) may be attached to a line at a distance from a single terminal circle hook. The distance of nearest fly to the hook is generally not less than 4 inches. This is to prevent the fish from drawing the hook into its mouth cavity. Fish, such as trout, are ram-suction feeders that are able by means of the vacuum formed by the mouth opening and coupled with their forward speed are able to pull food items into the mouth from distances equal to 1.5 times the length of their head. This general formula may be used to position the nearest fly to the hook.

In accordance with another aspect of the present invention, the hook-less fly is crafted on a fly body that consists of a hook-less core onto which the fly is tied, an attachment loop to affix the fly to the line and an optional line orientation structure. The fly body can be manufactured as an integral unit containing all three components or each component may be manufactured separately and assembled during the fly tying process. A preferred manufacturing method, when not intended for fish capable of biting through the fly, is an injection molding process forming the core and attachment loop as a single integral unit. A recyclable thermoplastic elastomer is desired for this purpose. The fly body, components and means of attachment can vary as a function of the species of fish sought, fly being tied and preference of the fly tyer.

The components of the fly body of one aspect of the present invention, including a core, an attachment loop and a line orientation device, may be crafted separately and connected during the fly tying process or manufactured concurrently and comprising a single and integral pre-made unit. Additionally, the materials of the fly body's construction for the various components of the present invention can be dissimilar materials and any or all can be further coated or uncoated with an additional material(s).

The fly body's core described for one aspect of the present invention can be of any material, shape or length. The ultimate design parameters depend upon the targeted fish and the fly being dressed.

The fly body's core length is preferably, but not necessarily, the equivalent to a conventional fly's hook shank length when comparing similar fly patterns and sizes. A tied nymph, as an example, for a given pattern may have a body length of 7 mm tied to a hook shank. The fly body core would as a result be 7 mm in length. The hook shank's length is a determining factor in hook choice when tying conventional flies. The shank must be sufficiently long to form the fly's structural base to which the fly dressing is attached during the fly's creation. The hook-less fly body's core serves the equivalent purpose and as such must be of equivalent length.

Conventional flies tied to a hook are limited to the steel hook's core to serve as the fly's foundation or structural support. The hook-less fly body's core is not so constrained and greatly expands the available materials and options to the fly tyer.

In a preferred embodiment the core is composed of an elastomer such as synthetic rubber. An elastomer fly body core yields advantages to both the fly tyer and the angler when in use.

A hook-less fly in the preferred embodiment is crafted by inserting a rigid mandrel into a fly tying vice. The fly body core is laid upon the mandrel and fixed to it by means of thread. Fly dressing materials including feathers, furs and synthetic materials are affixed to the core by means of thread and/or glue to create any fly pattern or type familiar to those in the art of fly tying. The fly when completed is pulled free by hand from the mandrel. A void within the fly, equivalent to the mandrel's diameter, may result. A void in the base of the finished fly can compromise the thread tension holding the fly dressing in place causing the fly to come undone. An elastomer core compresses under the thread tension during the tying process and then expands when the fly is removed from the mandrel filling any void space that may have been created. The fly dressing as a result of the rebounding elastomer core is kept firmly in place.

The diameter of the fly body core, in a preferred embodiment, is equal to or greater than the diameter of the mandrel on which the fly is tied. A finished hook-less fly's structural integrity is enhanced if the elastomer core can rebound sufficiently to fill the entire void created by the removed mandrel keeping tension on the threads and fly dressing.

A fly body with an elastomer core provides for new fly tying techniques and resulting fishing flies not possible with flies tied to a straight and rigid metal shaft of the hook shank. A fly tyer, stretching the elastomer core while fixing it to the mandrel can cause the finished fly to take various curved shapes when pulled free of the mandrel. The curves are produced by the elastic material of the core attempting to return to its relaxed state but prevented from doing so by the tying thread and material. The intensity of the produced curves in the fly is a function of the degree to which the core is initially stretched on the mandrel. The curved shapes possible with hook-less flies more accurately mimic natural food items and thus increase the likelihood of being accepted by a fish.

In another preferred embodiment the fly body core consists of synthetic polymer foam of either open or closed cell construction. The construction of conventional foam flies tied and glued to a hook are well known to the art of fly tying and most often created when tying patterns to imitate floating insects such as ants or beetles. Various materials are tied to the foam to imitate an insect's legs and wings but part of the foam is left exposed to imitate the insect's abdomen or thorax. A foam fly body core, unlike many other fly patterns, may also plays a role in the representation of an anatomical feature corresponding to a natural food item. The hook-less fly body's core as such may not be entirely covered by other materials and thread. The foam core, however, still serves its primary purpose of establishing the structural base upon which the fly is tied and the point of connection for attachment loop and optional line orientation structure.

A hook-less fly freed of the metal hook base permits the fly tyer to pay closer attention to the specific gravity of the flies allowed by the method. Dry flies, as an example, can be crafted without consideration to the amount of material required to offset the weight of hook and needed for the fly's flotation. A more natural appearing fly, using only sufficient fly dressing to imitate the food item, may be produced as a consequence.

Most subsurface food items preyed upon by fish have a specific gravity of 1.1 that is slightly less than water's 1.0. The specific gravity of a steel hook by contrast is 7.8. Hook-less flies tied with a non-metal core can more accurately reflect the natural food item's specific gravity. This allows the fly to drift in and with the water's current in a more natural manner leading to an increased chance of selection by a fish.

The formulation of the fly body polymer core can be amended with tungsten powders or other like materials during manufacturing to produce a rapidly sinking fly. The fly body core can also be closed cell foam if a highly buoyant fly is desired.

A preferred embodiment for the fly body core when fishing for fish, such as pike, capable of severing the fly is to protect the elastomer core with a non-elastic yet flexible abrasion resistant coating or covering. An example is the insertion of an elastomer core into a hollow braid composed of a material such as Kevlar. The core would demonstrate the required elasticity to fill the void left by the mandrel and provide protection from being severed by a fish's teeth. An abrasion resistant material utilizing manufacturing processes familiar to those in polymer chemistry including spray coating may additionally coat the core.

Inserting a wire into a hollow elastomer tube creates an alternative embodiment for the fly body core. The wire contributes support and protection to the fly body core from a fish's teeth while maintaining the ability to be loop connected to the line if extended as an attachment loop.

A further embodiment for the fly body core is the use of a metal shaft tied on the mandrel. The metal shaft requires the use of considerable glue to seal the mandrel created void and is not a recommended option.

A further embodiment is a metal shaft core inserted directly into the vice for tying and eliminating the need for a mandrel. The fly when completed is removed from the vice and the exposed metal shaft, previously held by the vice, is mechanically severed from the fly.

A further embodiment to create a fly body core is a plastic with a durometer value higher than elastomers. These materials while being far more elastic and flexible than a metal hook will not demonstrate the rebound effect required when the mandrel is pulled from the finished fly. The fly body core when made of such a material, vinyls as an example, would be molded by a manufacturing process such that a lengthwise indentation would be formed the length of the core. The indentation being of sufficient width to accept the mandrel into the formed cavity. The vinyl has sufficient rigidity coupled with the cavity produced in molding to produce a stable finished fly despite the mandrel's void.

In each of the previously described embodiments, the core when created separately from the attachment loop may be of any material, with minor reservations, however an elastic material is preferred. An elastic core rebounds to fill the void formed when the finished fly is pulled from the mandrel. The void left by the mandrel has the capability of releasing the thread tension holding the material to the core and allowing the fly to come undone. Glues are able to overcome this problem but are not a preferred means except when dealing with fish capable of severing the fly with their teeth.

In accordance with one aspect of the present invention, the core of the fly ultimately has an abutted attachment loop for connection to the fly line. The attachment loop, in accordance with another aspect of the present invention may be an integral part of the hook-less fly body and manufactured as a single unit comprising attachment loop and core. Alternatively, the attachment loop can be created separately from the core and affixed to the core during the fly tying process by barbs, tying thread, crimps, solvent welding, glues, compression fittings or any method compatible with the materials of construction. Further, the attachment loop may incorporate a distal post structure capable of being manually inserted into the fly's core. The post may be constructed with or without barbs to aid in connection to the core and may use glue at the fly tyer's discretion.

In accordance one aspect of the present invention, a synthetic elastomer with good wet strength grip, high coefficient of friction, good UV and ozone resistance, low durometer (Shore A less than 60), good elongation and tear strength is the preferred material for the line attachment loop. For example, synthetic rubber can be used. When fishing for fish capable of biting through the line other options are available and described herein. The attachment loop can gain added strength, when required, by incorporating a shape memory alloy such as Nitinol that is coated with an elastomer or inserted into an elastomer sleeve or tube.

The attachment loop may be formed on the end of a post. The post being constructed of any suitable material, and may or may not incorporate barbs or indents on the post. A fly tyer, as an example, using a cylindrical foam core to tie flies may find it advantageous to have an elastic attachment loop fixed to a metal post or pin that can be inserted and glued into the foam core during the tying process. Alternately the elastic eye loop may be attached to a less rigid post that can be affixed to the core by means of thread during the tying process. The attachment loop and post do not have to be of like materials.

In accordance with one aspect of the present invention, the fly of the present invention can be attached to the line by threading a loop of line through the attachment device and once through passing the body of the fly through the resulting loop. Pulling on the line will cause the fly to remain in place while casting.

In accordance with another aspect of the present invention, frictional and/or molecular forces accomplish the fixing of the attachment loop to a specific point on the line.

In accordance with a further aspect of the present invention, the attachment loop of a hook-less fly or the fishing line may be coated with a material to increase the coefficient of friction to allow the fly to remain in place.

In accordance with another aspect of the present invention, the fly can be moved by grasping the standing line at a point above or below the fly and pulling said fly in a direction opposite the hand grasping the line.

In accordance with another aspect of the present invention, the material comprising the attachment loop of the hook-less fly is an elastomer such as natural or synthetic rubbers. In accordance with a further aspect of the present invention, the material comprising the attachment loop of the hook-less fly may be a flexible abrasion resistant material such as Kevlar. The material comprising the attachment loop or sleeve when used can be a monofilament or multifilament such as a braid or furl. The attachment loop and/or abrasion resistant sleeve may be of hollow construction. In accordance with yet another aspect of the present invention, the attachment loop of the hook-less fly is a shape memory alloy in wire form and may be coated or uncoated with an additional compound. The shape memory wire may additionally be inserted into a hollow elastomer tube. In accordance with a further aspect of the present invention, the attachment loop of the hook-less fly may be coated with dissimilar compounds.

In a preferred embodiment, the fly is attached to the line by threading a loop of line through the attachment device and passing the body of the resulting fly through the resulting passed loop. The elastic nature of the attachment loop deforms under pressure from the line and allows the line to remain straight without any reduction in ultimate breaking strength. The full potential breaking strength of the line is maintained as a result of fixing the fly to the line without the need of knots. The fly is held in place on the fishing line by the high coefficient of friction and by molecular forces exerted between the elastomer used to make the attachment loop and the line. The connection is not to be confused with a loop-to-loop connection that would require a permanent loop in the standing part of the fly leader line.

The fly remains in place on the line while fishing but may be repositioned by grasping the standing line at a point above or below the fly and pulling the fly in the opposite direction. The fly may be easily removed from the line by reversing the looping process. There is no need to separate the line or the hook from the line to add or remove flies.

In accordance with another aspect of the present invention, the hook-less fly can include a line orientation structure, attached to the core (comprising the fly body) and capable of orienting the line parallel to a desired axis of the fly in conjunction with the attachment loop. The line orientation structure may be of any material, shape or desired length, and is a function of a number of factors, such as the targeted fish and fly pattern.

Some hook-less flies benefit when rigged with a distal line orientation device as previously described. This structure, generally a loop knotted at the end of a flexible post or shaft, allows the angler to orient the line parallel with a desired axis of the fly. The post or shaft is either stuck into the core or tied onto the core. The line is oriented to the fly's long axis when using the distal structure described above. Rigging is accomplished by threading the terminal hook a single time through the line orientation device's loop or other such structure. The structure need not yieldingly hold the fly to a specific point on the line like the attachment loop but functions to keep the line in the preferred plane. A line connected only by the attachment loop would be able to slide on the line. An angler may prefer to loop the line to the device but this is rarely a requirement. The line orientation device is generally used in conjunction with an attachment loop.

The line orientation device is not needed with all flies but is an option to prevent the some fly patterns from creating a “helicopter effect” when being cast. Such a fly spins in the air twisting the line and tangling upon it. Flies, such as dry flies, tied with materials at a severe angle with respect to the fly's long axis can cause excessive air resistance during the act of casting. The more resistant this material is to folding towards the fly body while being cast through the air the more resistant likely it will produce this undesired effect. The orientation of the line along the fly's long axis, using the described orientation structure, is a preferred embodiment for all but the smallest streamer flies and larger dry flies. Most nymph and wet flies do not need the structure except in the larger sizes. The point of demarcation when a line orientation device is desirable is dependant on overall fly length, width, density and materials used in construction. Orientation with the long axis is generally preferred when a line orientation device is warranted, but not mandated. The two points of connection described for the hook-less fly, line orientation device and attachment loop, allow fly patterns to be effectively fished that are rarely used as conventional flies because of the above described aerodynamic problems.

In a preferred embodiment the line orientation device extends no farther than the most distal point of material extending from the finished or dressed fly.

The device can take the form of a loop or any other structure capable of producing the desired result. A loop, as an example, may be formed at the distal end of a flexible shaft of polymeric material such as nylon monofilament. Regardless of the material used, the resulting loop must be large enough to pass through the line-attached hook. This structure is most often a polymer monofilament. The line orientation structure may also be manufactured as a single unit in conjunction with the fly body's core and attachment loop. The line orientation structure can be constructed of a range of materials to achieve the desired objectives. These may include, in addition to the material described above, metal or abrasion resistant synthetics such as Kevlar. An abrasion resistant material is preferred when fishing for fish such as pike or bluefish that have the ability to bite through the structure.

The line orientation device does not have the requirement for fixing the fly to a specific point on the line. The device is therefore not as restricted by the materials of construction as is the attachment loop.

In accordance with a further aspect of the present invention, the line orientation structure can be manufactured as a single unit in conjunction with the fly body core or integral fly body core and attachment device.

The line orientation structure of the present invention may or may not be capable of fixing a fly to a specific point on the line. Thus, this structure does not have to be an attachment point keeping the fly in a certain spot on the line. A fly rigged by this attachment, for descriptive purposes only, and without a primary attachment loop would be capable of sliding along the line.

A hook-less fly may alternatively be attached to the line by means of an intermediary line attachment device. The line attachment device is so constructed that can be affixed to the line at a specific point. The device is placed by the angler at a desired point on the line above the hook. Once attached to the line a fly is subsequently connected. The device is most often a bead shaped structure that may be crimped, glued, or held to the line by compression fitting. A split shot, as an example having a diameter larger than the diameter of the attachment loop is crimped to the line. The hook point is threaded through the attachment loop and pulled up the line to the split shot acting as a stop device. Further pressure on the hook-less fly causes the elastic material used to create the attachment loop to expand sufficiently to pass over the stop device. The elastic attachment loop then rebounds to the smaller diameter of its resting state. The attachment loop's resting state being too small to allow the fly to slide in the direction of the hook.

A line attachment device can be a bead with a cavity capable of accepting a plug. The plug can have a lengthwise split capable of capturing the line before the plug is inserted into the bead. The fly's elastic attachment loop is stretched over the bead and trapping the fly's attachment loop between the beads larger diameter and the line. The plug may have an attached fitting to facilitate later removal. The bead may be of any color, finish or size suitable to the use. The bead may also have protuberances to imitate the eye structure or other anatomical features desirable on the crafted fly. The bead may also have a length wise split on one side of the bead intercepting the cavity. The line is inserted lengthwise into the slit reaching the cavity and is held firmly in place on the line by the inserted plug.

The use of a line attachment device broadens the materials that may be used in the creation of the attachment loop to include abrasion resistant synthetics such as Kevlar or shape memory alloys such as Nitinol. In this alternative embodiment the attachment loop is not expanded over the bead. The non-elastic attachment loop, smaller in diameter than the bead, is captured between the line and the bead by means of inserting the plug through the line attachment loop.

Nitinol is a shape memory alloy with superelastic properties allowing the material to behave more like an elastomer than a metal. Nitinol unlike elastomers is abrasion and cut resistant making it a good material for the attachment loop and line orientation device when needed for fish such as pike or bluefish. The innate elasticity of Nitinol allows it to be coated with an elastomer, with a high coefficient of friction, and optionally looped directly to the line without need of an attachment device.

An attachment loop made of Kevlar, Nitinol or similar material may also be affixed to the line by means of a line attachment clip. The clip can be attached to the line by means of tortuous path or crimping.

The attachment device can also take the form of a barbell-like structure formed by means of two spherical halves, one being the female side and the other the male side. The female side incorporates a cavity capable of accepting the plug attached to the male side. The plug has a length- wise slit through which the line is passed before mating the two sides. The plug device may have prongs on the distal end that protrude from the far side of the female cavity to aid in holding the pieces together. The attachment loop of the fly is stretched over either side in the case of an elastic attachment loop or captured between the sides, for non-elastic, when mated together.

In accordance with another aspect of the present invention, a fly may be affixed to a line attachment device located on the line at a distance from a terminal circle hook. In accordance with another aspect of the present invention, the line attachment device can be a structure of any shape and material. The line attachment device can be attached to the line by tortuous path, loop-to-loop connection, adhesives, crimping, knots, compression fittings or other familiar methods. The line attachment device can be attached to the line without the requirement to part line from hook.

In one embodiment of the present invention, a hook-less fly has the terminal hook threaded through the elastic eye of the fly and fly pulled up the line and over the line attachment device. The elastic nature of the attachment loop allows it to expand over the line attachment device then rebounds to its unstressed size preventing the hook-less fly from sliding towards the terminal hook. In a further embodiment of the present invention, the line attachment structure allows a fly to be attached by expanding the elastic eye over the attachment device and allowing the attachment eye in a relaxed state to be held by means of an indentation in the line attachment device. In another embodiment of the present invention, a hook-less fly has a shape memory alloy attachment eye that may be clipped or looped to an attachment device.

In an additional embodiment of the present invention, the attachment eye of a fly can be attached to the line by a compression fitting containing one or more parts.

In a further embodiment of the present invention, a fly may be looped upon a barbell-like structure attached to the line.

It is understood that both the foregoing general description and the following detailed description are exemplary and are intended to provide further explanation of the invention claimed.

The accompanying drawings, which are incorporated in and constitute part of this specification, are included to illustrate and provide a further understanding of the apparatus and method of the invention. Together with the description, the drawings serve to explain the principles of the invention.

### BRIEF DESCRIPTION OF THE DRAWINGS

FIG. 1 illustrates a conventional fly-fishing rig.

FIG. 2 illustrates a fly-fishing rig in accordance with one aspect of the present invention.

FIGS. 3 and 4 illustrate a fly being tied in accordance with one aspect of the present invention.

FIG. 5 illustrates a flexible rubber core having an eye formed as the material is folded onto itself and that can be used when tying a fly in accordance with another aspect of the present invention.

FIG. 6 illustrates a molded core having a preformed eye and a length-wise indentation that can be used when tying a fly in accordance with another aspect of the present invention.

FIG. 7 illustrates a tube that can be used when tying a fly in accordance with another aspect of the present invention.

FIGS. 8 to 12 illustrate a preferred method of attaching the hook-less fly of the present invention to a fishing line.

FIGS. 13 to 15 illustrate the approach of a fish to the fly-fishing rig of the present invention and a preferred method of hooking a fish.

FIG. 16 illustrates a rubber loop attached to a tube while tying a fly in accordance with another aspect of the present invention.

FIGS. 17 to 19 illustrate the attachment of a tube to a fishing line in accordance with a preferred embodiment of the present invention.

FIGS. 20 to 21 illustrate a nymph attached to a fly line in accordance with one aspect of the present invention.

FIGS. 22 and 23 illustrate the addition of a bead to a hook-less fly in accordance with one aspect of the present invention.

FIG. 24 illustrates a hook-less fly and a traditional fly attached to a fly line.

FIG. 25 shows a hook-less fly incorporating an elastic attachment loop that is loop connected to a fishing line at a fixed distance above a barb-less, non-off-set C or circle hook.

FIG. 26 shows a fly body for a hook-less fly that forms the equivalent functions of the hook eye and shank in a conventional fly where the fly body contains an attachment loop for connection to the line, a core onto which the fly is crafted and an optional line orientation structure to orient the fly and line along a preferred axis while fishing.

FIG. 27 demonstrates the various fly bodies onto which a hook-less fly may be crafted.

FIG. 28 exhibits a dressed fly attached to a fly line with a loop threaded through the loop attachment device and with a hook threaded once through a line orientation structure such that the line runs parallel to the long axis of the fly.

FIG. 29 demonstrates a preferred connection of a C or circle hook to a line in accordance with one aspect of the present invention.

FIG. 30 demonstrates an alternate connection method that utilizes a stop device affixed to the line at a distance above a hook.

FIG. 31 shows a line attachment device consisting of paired male and female halves and a connected hook-less fly.

FIG. 32 describes a line attachment device with a beadlike female structure incorporating a cavity capable of accepting a plug with a lengthwise split to capture the line and affixing the line attachment device at a distance above the hook.

FIG. 33 shows a fly body preferred to be used when fishing for species, such as pike or bluefish, capable of biting through the fly.

FIG. 34 shows a line attachment device for a fly tied on a fly body as described in FIG. 32.

FIG. 35 shows an further embodiment of a fly body in accordance with another aspect of the present invention for use with fish such as pike and bluefish and further described in FIG. 33 above.

### DETAILED DESCRIPTION

In accordance with a preferred embodiment of the invention, apparatus and methods are provided for improved fly-fishing and resource protection.

Advantageously, the hook is not required to enter the inside of a fish's mouth to affect capture. This eliminates the mortal risks associated with a hook piercing a fish's internal organs.

Another advantage finds the circle hook engaged in the outer jaw, exposed with the hook eye facing out, allowing for a simple and speedy hook extraction and fish release. The reduced handling stress associated with the simple hook extraction, not needing to access a hook deep in the mouth cavity, promotes an increased rate of survival for released fish.

Another advantage is the hook-less fly allows the hook-set to be in the opposite direction with respect to conventional fishing. This exposes the hook to the much more defined edge located on the outside of the jaw.

Another advantage is that circle hook use benefits from exposure to this more defined hooking surface. The more defined edge accessible when using a hook-less fly overcomes all the limitations imposed on conventional circle hook use.

Another advantage is that a fish's outer jaw provides a surface to which the circle hook can firmly engage and overcomes the need to fight the fish using gentle line pressure.

Another advantage is that hook-less fishing flies can take full use of the resource advantages, inherent to circle hooks, across the entire range of fly types and sizes.

Another advantage is the method allows much smaller circle hooks to be used than is possible with conventional flies crafted upon a circle hook or many fly dressed J-hooks. Smaller hooks equate to less mortality or maiming of undersized fish.

Advantageously, the defined outer jaw edge allows the angler, in response to a fish's taking the hook-less fly, to strike the fish by jerking the rod in traditional manner. This is not possible with circle hooks when used in conventional fashion and a major reason why anglers have not embraced the circle hook.

Another advantage promotes the efficiency of hook set by separating the fly from the hook. The fly dressing, as a result, cannot interfere with the hook point or decrease the effective hook gape.

Advantageously the invention eliminates the requirement of conventional flies that fly size and hook size must be related. The hook-less fly allows small hooks to be used with large flies decreasing the incidence of serious injury to all sizes of fish.

Another advantage is allowing circle hooks to be used in all fly fishing situations and with all fly sizes and pattern. The incidence of foul hooking fish is greatly reduced as a consequence.

Another advantage is minimal retraining is needed on the fly tyer's part to create most known fly patterns.

Another advantage is fly patterns can be created that are not possible for flies constrained to a straight metal hook shank.

Advantageously the hook-less flies cannot rust destroying their use. Cadmium or other such plated hooks used to prevent conventional hooked flies from rusting are harmful to the environment and to the fish. Plated hooks are not required when fishing with hook-less flies.

Advantageously, a fly-fishing fly that does not require the line to be parted or disconnected from the terminal hook to change or remove a fly(s) is presented. The flies can be added, removed, or re-positioned on the leader without the need for new knots thus greatly speeding and simplifying the changing of flies.

Another advantage is that two or more flies can be fished on a single line terminating in a single circle hook without producing line tangles when fishing.

Another advantage is that more aerodynamic flies can be crafted which reduce line twist and associated tangling of fly and line.

Another advantage of the current invention is that the learned aversion of fish to the hook shape and to objects that do not orient correctly with regard to the water current is overcome.

The current invention also advantageously provides a soft fly body, which leads to a longer retention time by a fish, enhancing strike detection and hookups. The ability of the angler to detect a strike before the fish has expelled it from its mouth is a major factor in success.

An additional advantage offered by the present invention is that the flies can assume more natural shapes than flies crafted directly on a hook and are, better able to mimic natural food items.

An additional advantage is the fly can more naturally duplicate the specific gravity of natural food item and as a result drift more naturally with the water currents.

An additional advantage is being freed from the hook a dry fly so constructed is able to float better while requiring a minimum of fly dressing for this purpose.

An additional advantage is the fly(s) are connected to the line without the need for knots maintaining the line's full breaking strength. Knots have the potential to reduce the breaking strength of the fishing line.

The invention also offers the advantage of using small hooks with large flies, reducing the mortality rate of released fish.

Advantageously, the invention allows for easy alteration of the fly from weighted to un-weighted and from beaded to non-beaded flies using the same basic fly form.

Another advantage of the current invention is that the invention greatly reduces the numbers and styles of hooks that need to be carried by a fly tyer.

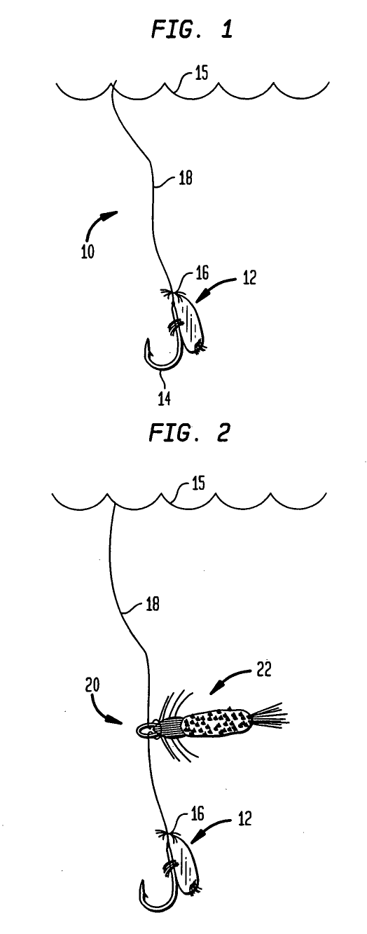

FIG. 1 shows an exemplary fly-fishing rig. A traditional fly rig 10 includes a fly 12 with an integral hook 14 connected at the end 16 of a fishing line 18. The hook 14 being an integral part of the fly 12 means that the fly 12 is constructed, or tied, around the hook. Fishing line 18 typically extends below and above (not depicted) the surface 15 of the body of water being fished.

FIG. 2 illustrates a fly rig in accordance with one aspect of the present invention. The fly rig 20 includes a hook-less fly 22 attached to a fishing line 18 some distance from the end 16 of the line 18. This distance may vary from a minimum of slightly greater than zero inches to several feet, depending on the type of fly employed and other factors. In an embodiment, a hooked fly 12 can be attached to the end 16 of the line 18. The fishing line 18 may be of any number of materials such as nylon or fluorocarbon.

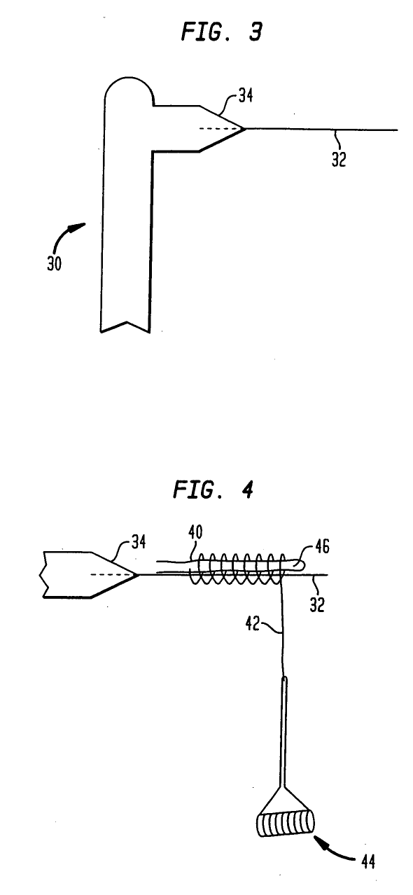

FIGS. 3 and 4 illustrate an exemplary process of tying hook-less flies. Other well-known processes may be employed. The fly is not tied on a hook but instead is constructed using standard fly tying tools such as the fly tying vise 30 shown in FIG. 3. A mandrel 32 is inserted into the jaws 34 of the vise 30. In FIG. 4, a core material 40 is attached to the mandrel 32 by means of tying thread 42 from a thread spool 44. Various materials familiar to one skilled in the art may be used for tying thread. The core material 40 may be a variety of materials also. As an example, FIG. 4 shows a flexible rubber material used as a core material 40 folded onto itself in order to form an attachment loop 46 during fly tying. One or more materials that form a pattern representative of food available to the fish may surround the core. These one or more materials include, by way of example only, beads, feathers, and threads. These materials are tied onto the fly in accordance with well-known fly tying techniques. Of course other materials commonly used in fly tying can also be used.

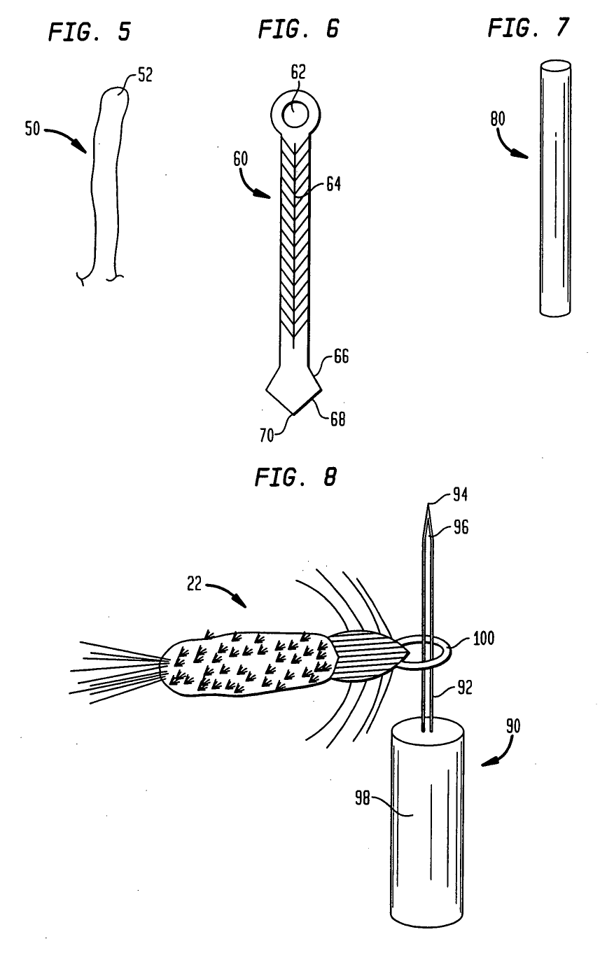

Although many materials may be used, FIGS. 5-7 showcase several types of core materials. Some core materials are rubbers, plastics, or metals in sheet, cord, tube, or molded form and may be rigid or flexible. In sheet or cord form, an eye is formed on one end of the fly in order to attach the line. The molded form has the eye already incorporated. FIG. 5 shows a flexible rubber core material 50, such as a rubber string, folded onto itself with an eye 52 formed by the folding. FIG. 6 shows a molded core 60 with a preformed eye 62 and an indentation 64 along its body. The molded core may also have a tailpiece that easily fits in standard tying vices and can be readily snapped off once the fly is tied. The molded core 60 may have a flared end 66 that tapers 68 near its termination 70. FIG. 7 depicts a tubular core. A tube 80 can be attached to a fishing line in numerous ways, some of which will be described below.

Additionally, the core does not need to be flexible, but still should not include a hook. It is, however, believed that an inflexible core could reduce the effectiveness of the fly due to the restricted movement. The smaller the fly, however, the less important the characteristic of flexibility is thought to be. Thus, it is believed that an inflexible material can also be used in the core.

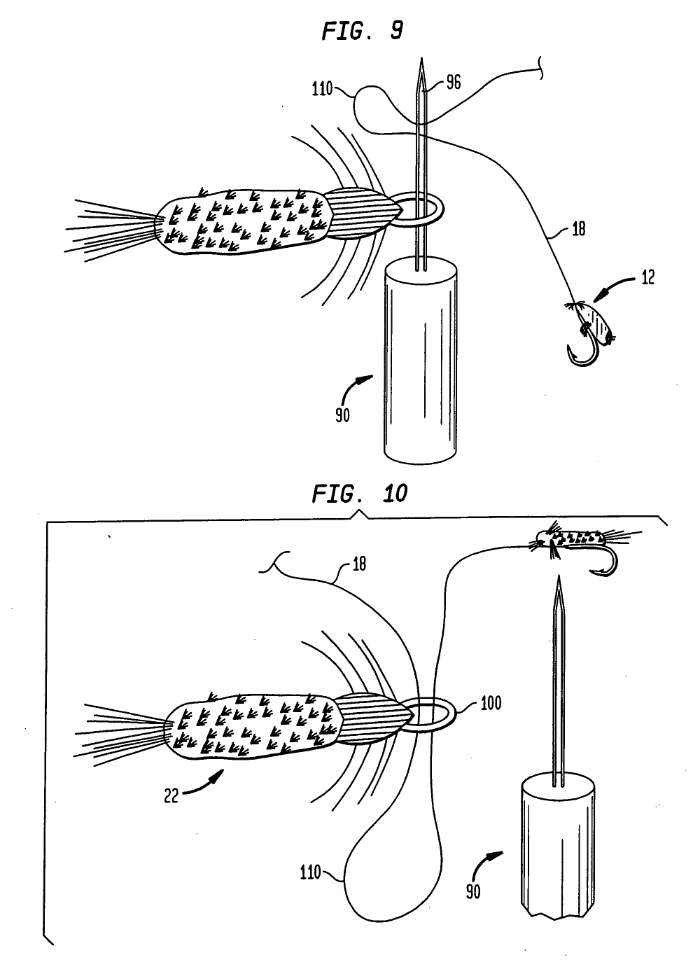

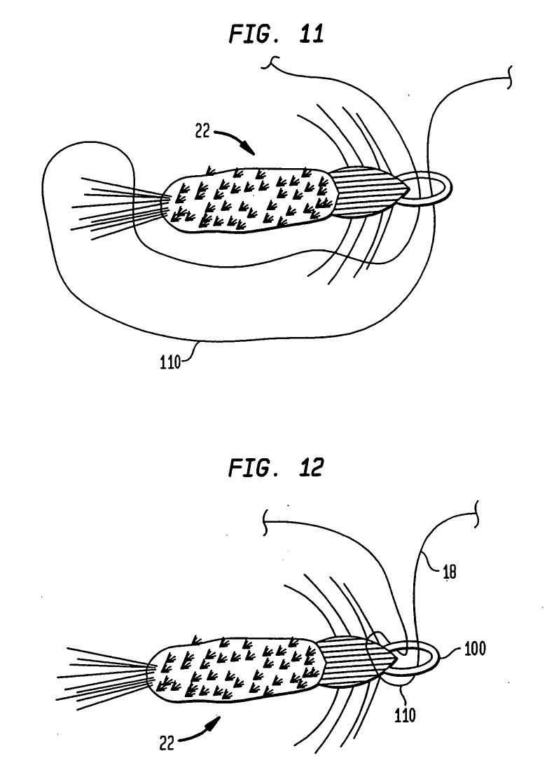

In an embodiment, a finished fly with attachment loop is connected to an angler's line by looping a fishing line through the eye loop of a fly and pulling the loop over the body of the fly. FIG. 8 is one embodiment that uses a threading tool to accomplish the attachment. The threading tool 90 consists of a fine wire 92 bent back on itself, forming a tip 94 and a closed wire loop 96, with both free ends of the wire embedded in a handhold 98. Such tools are common to one skilled the art. The tip 94 of the threading tool 90 is inserted and pushed through the eye 100 of a fly 22. As in FIG. 9, the fishing line 18 is terminated on one end by a hooked fly 12 and a rod (not shown) on the other. The fishing line 18 is inserted into wire loop 96 of the threading tool 90 until it protrudes, forming a loop 110 of fishing line 18. In FIG. 10, the threading tool 90 and loop 110 of fishing line 18 are pulled back through the eye 100 of the fly 22 until a loop 110 of fishing line 18 longer than the fly 22 is formed, and the threading tool 90 is removed from the eye 100. Following FIG. 11, the loop 110 is pulled over the body of the fly 22, and, as shown in FIG. 12, the loop 110 is pulled tight around the fly's 22 eye 100. Friction allows the fly 22 to remain stationary while fishing, but the position of the fly 22 along the line 18 may be adjusted by pulling on one leg of the line 18 while holding the fly 22.

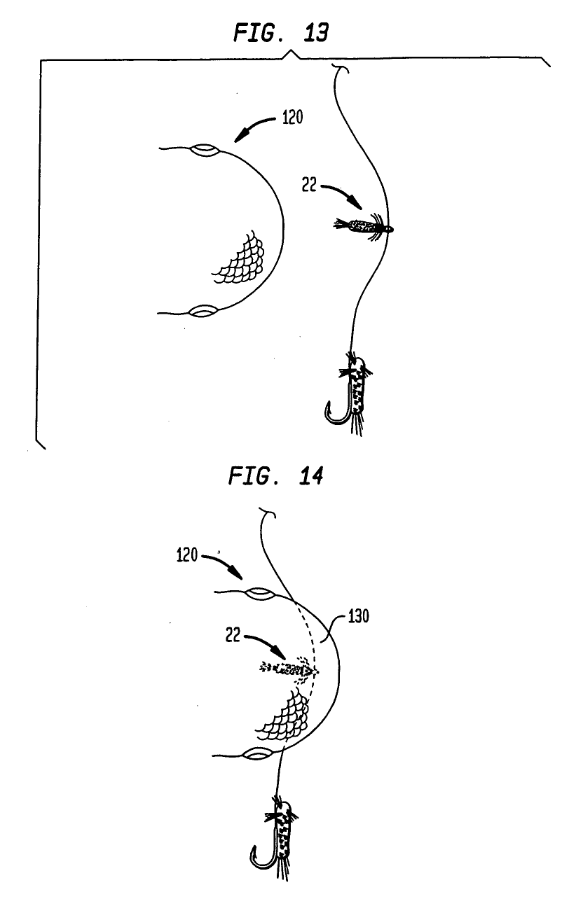

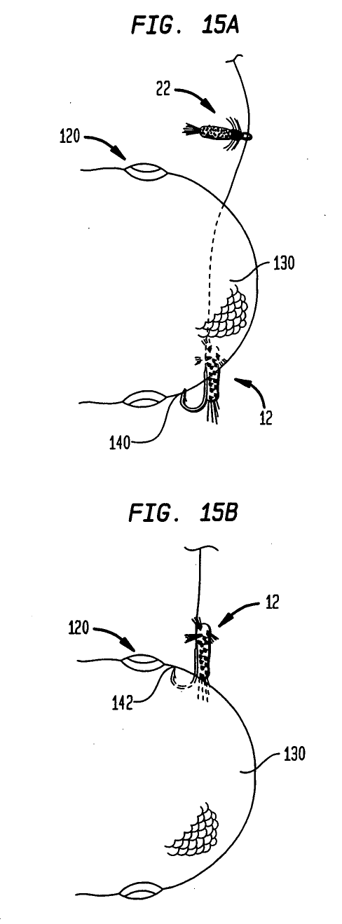

In traditional fly-fishing, a fish takes a fly with an integrated hook into its mouth, and an angler, sensing a take, pulls the line, which engages the hook in the fish's mouth. From FIG. 2, the inventive method provides for a hook-less fly 22 some distance from a conventional hooked 12 or bare fly attached to the terminal end 16 of the line. FIG. 13 shows a fish 120 approaching hook-less fly 22. As FIG. 14 depicts the fish 120 takes the fly 22 into its mouth 130 while the hook is external to the mouth. FIG. 15 demonstrates that as an angler, sensing a take, raises the fly rod, a hook-less fly 22 is pulled through the fish's 120 mouth 130, driving the terminal (hooked) fly 12 into the fish's 120 mouth 130. Referring to FIGS. 15(a) and 15(b), respectively, the hooked fly (or bare hook) 12 sets into the exterior 140.

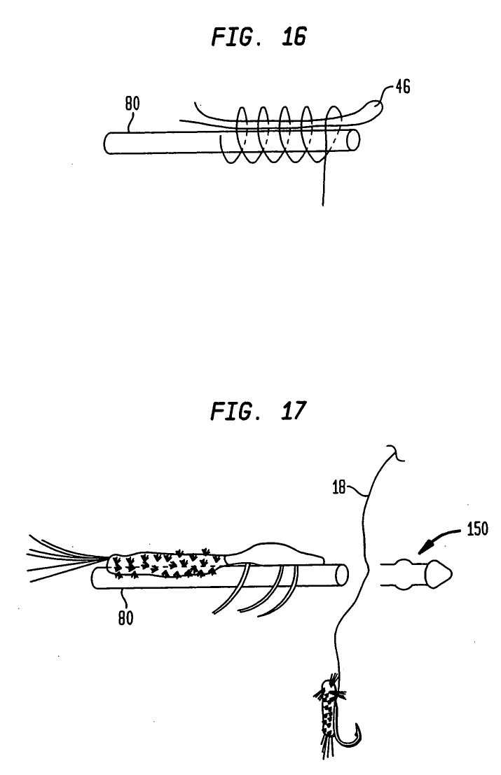

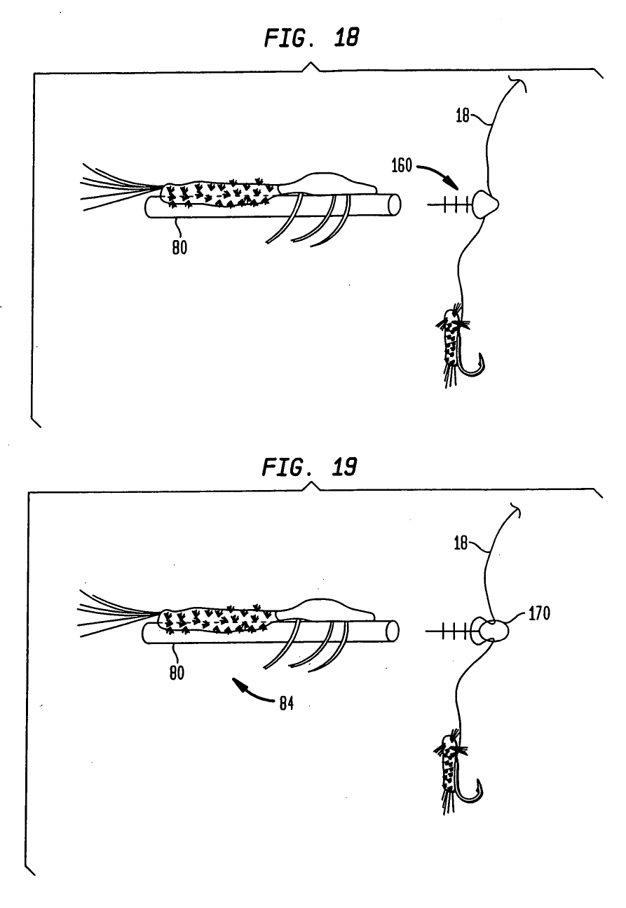

FIG. 16 shows a rubber loop attached to a tube. When a tube 80 is used as a core, a preferred embodiment contains an eye 46 that may be created as the fly is tied. Attachment to the line can be identical to the above process. FIG. 17 illustrates another embodiment where tube-containing flies with or without an eye may be attached to a line. An insert 150 can be used to attach a tube fly to a line 18. The tube 80 can be attached to the line 18 via a press-fit insert 150 whereby the line 18 is captured between the body of the insert 150 and the tube 80. FIG. 18 shows another embodiment where a tube 80 is attached to a line 18 using a crimp-based pin 160 pushed into the tube 80. FIG. 19 shows the use of an eye pin. An eye pin 170 may be inserted in a tube 80, and the fly 84 attached to the line 18 using the threading tool. Here, the fishing line 18 is directly attached to the eye pin 170 insert. The insert 150 can also be an eye loop or any other attachment device. The insert 150 may also be glued or press fit to the fly or tied onto the fly as an integral part of the fly with tying threads.

The inserts can be metallic or plastic, and the visual part of the insert can be various colored beads or an anatomical feature of the food item the fly is mimicking. The threading tool may also be pushed through the tube, capturing the line and a piece of rubber filament in the process and as a result affixing the line to the tube. The two trailing rubber ends at the tail of the fly are pulled tight to snug the fly to the line and either cut off or left to mimic the tail of a nymph.

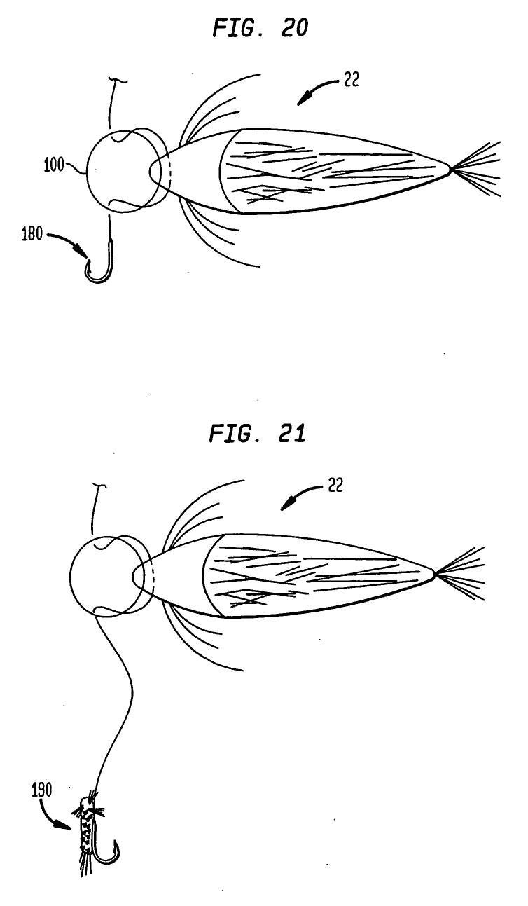

The inventive system allows traditional patterns to be fished with much smaller hooks. FIG. 20 shows a hook-less fly with a hook near the main fly body. Pulling a small hook 180 tight to the eye 100 of the fly 22 completes the rig. FIG. 21 shows another embodiment with a small free-swinging fly. The rig can be fished with a small free-swinging fly 190 some distance from the hook-less fly 22. The use of smaller hooks also allows advantageous use of lighter fly rods with large patterns and reduces injuries to fish.

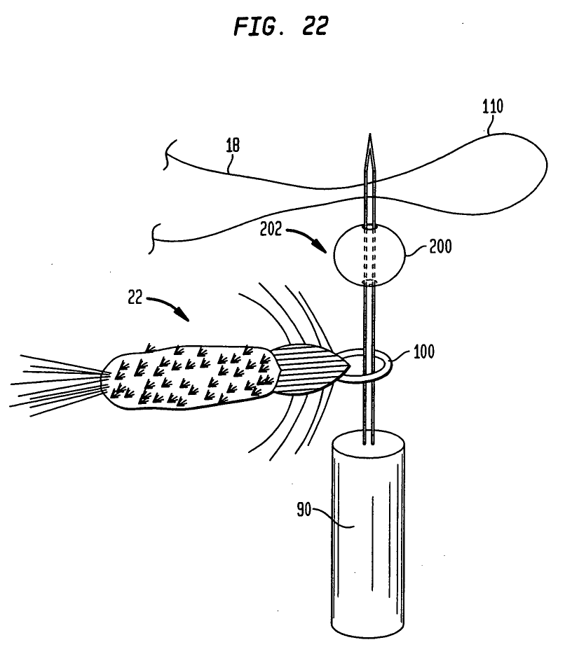

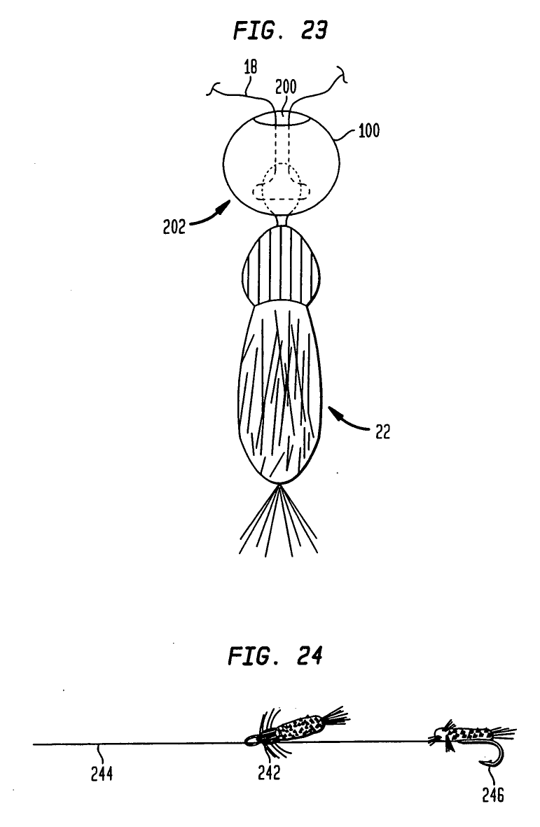

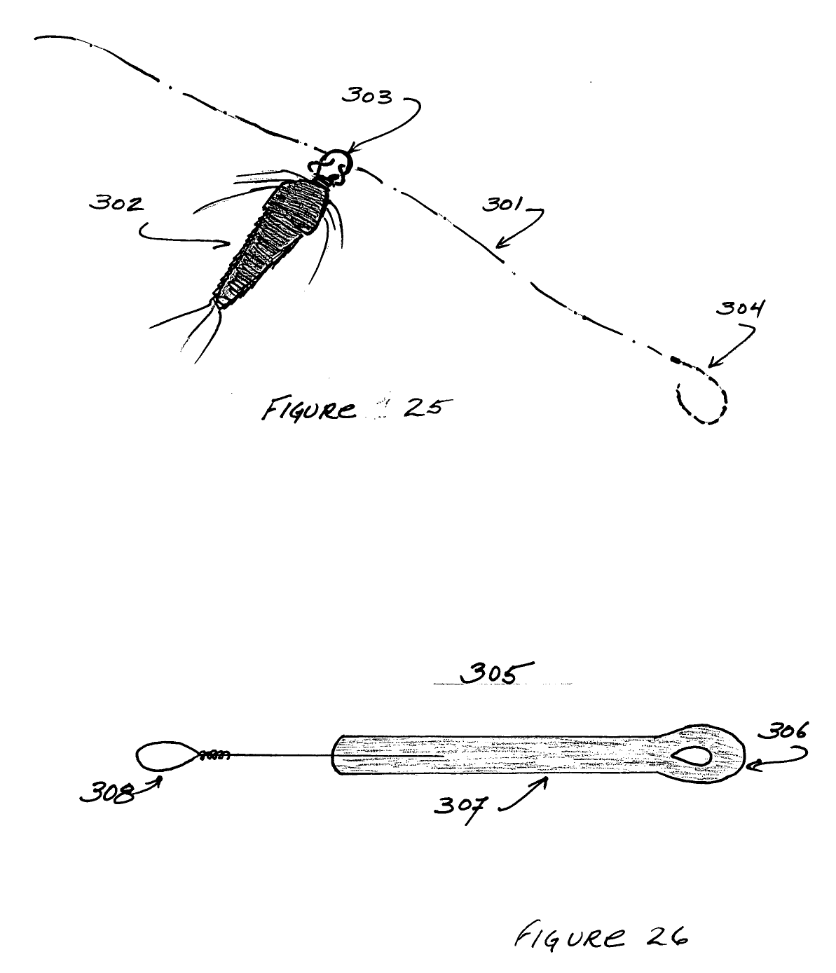

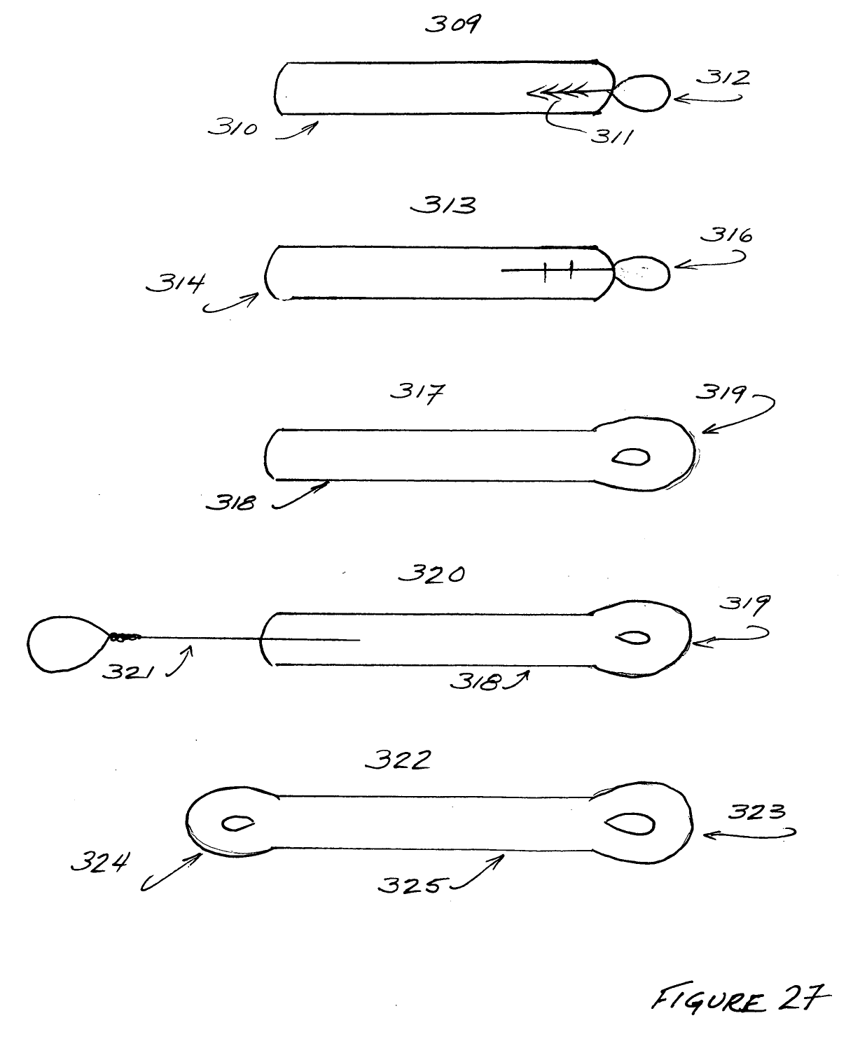

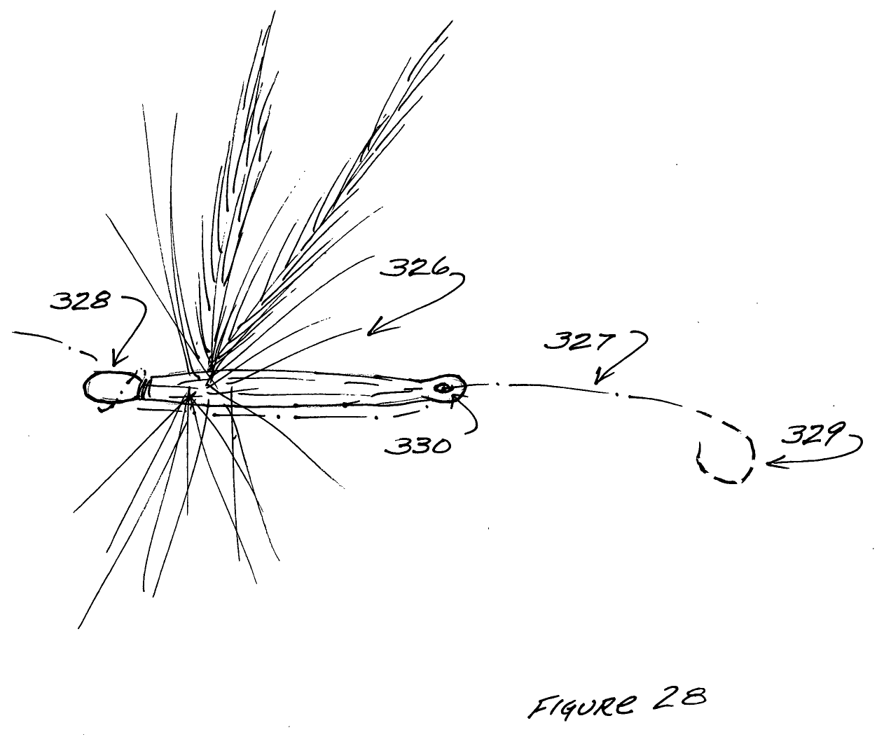

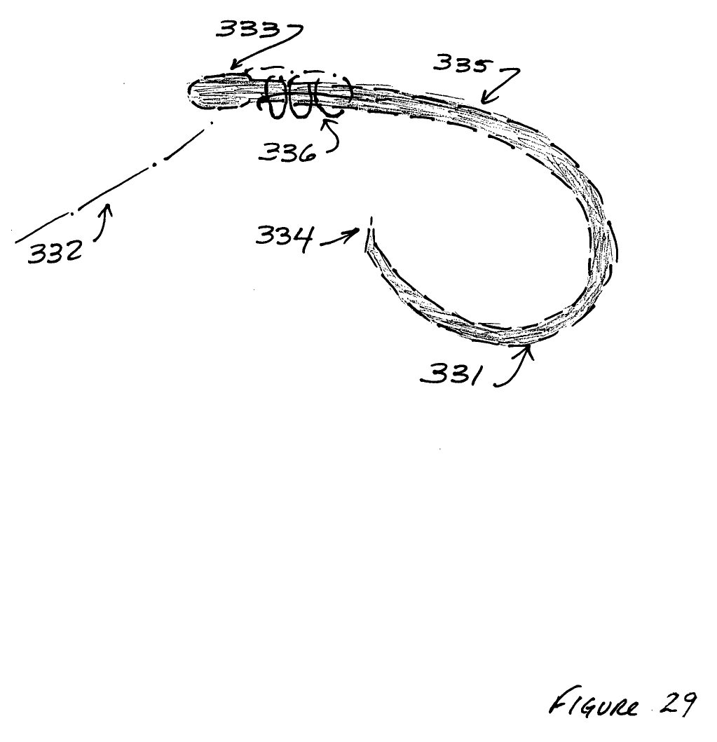

Advantageously, the inventive system also allows the angler to have one fly pattern and change beads or delete them at will, reducing the number of flies needed. FIG. 22 shows the construction of a hook-less fly with a bead. Here, a bead fly is assembled by passing the threading tool 90 through the eye 100 of a hook-less fly 22 and subsequently through the center hole 200 of as many beads 202 as desired. A loop 110 of fishing line 18 is made as before. FIG. 23 illustrates the completed fly with a single bead attached. The line 18 and the fly's 22 eye 100 are contained within the center hole 200 of the bead 202.

The apparatus and methods described herein are unique means for quickly and easily attaching or detaching hook-less flies and lures to a fishing line. The invention allows attachment or detachment of lures from fishing lines without cutting or disconnecting the line, decreases the cost incurred since one does not have to purchase such a large array of flies, hooks, and fly accessories, overcomes the learned aversions of fish to hook shape and incorrect orientation of objects with respect to the water current, as well as longer retention time of the fly by the fish, leading to greater strike detection and hook setting.

The flies assume more natural shapes than hooked flies, better mimic natural food movement on the water, and improve incorrect buoyancy properties (relative to natural food) of the flies. False strikes by an angler are reduced, which increases the time the fly is properly presented; the mortality rate of released fish is decreased through use of smaller terminal circle hooks; and changing from various weighted to non-weighted flies is simple and fast.

FIG. 25 shows a hook-less fly 302 incorporating an elastic attachment loop 303 that is loop connected to a fishing line 301 at a fixed distance above a barb-less, non-off-set C or circle hook 304. The circle hook 304 is unadorned or is minimally dressed. Putting a loop of line 301 through the elastic attachment loop 303 and then putting the fly 302 back through the resulting loop of line 301 finishes the loop connection.

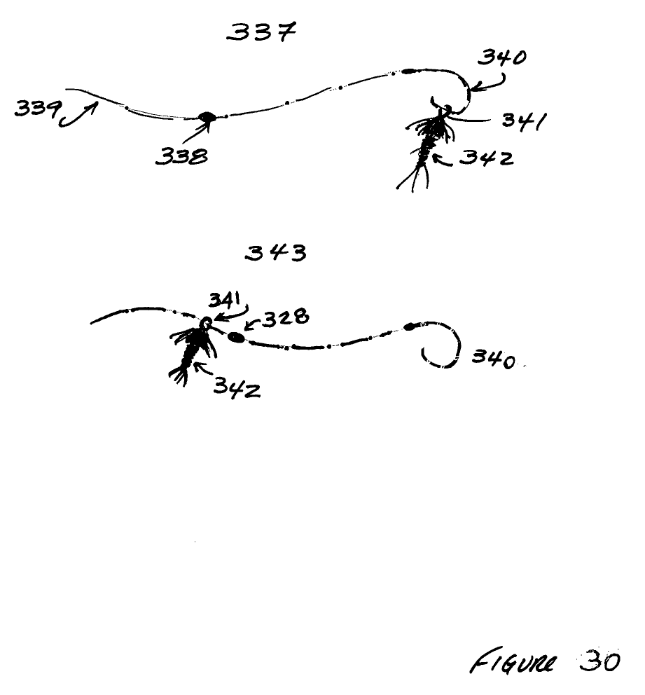

FIG. 26 shows a fly body 305 for a hook-less fly in accordance with one aspect of the present invention. The fly body 305 forms the equivalent functions of the hook eye and shank in a conventional fly. The fly body contains an attachment loop 306 for connection to the line, a core 307 onto which the fly is crafted and an optional line orientation structure 308 to orient the fly and line along a preferred axis while fishing.

FIG. 27 demonstrates various fly bodies onto which a hook-less fly may be crafted in accordance with various aspects of the present invention. A fly body 309 has a core 310 into which a barbed post 311 is inserted. The barbed post 311 contains a connected attachment loop 312 with the post 311 being made from a material stiffer than the attachment loop 312 to allow for insertion.

A second variation to create a fly body is shown in 313 incorporating a core 314 and a post 315 with a connected attachment loop 316 that is fixed to the core 314 during the act of tying the fly. The post can have a number of barb types or indents to aid in connection. The post 315 is therefore secured to the core 314 during the fly tying process when materials are wrapped around the core 314. The attachment post 315 does not need to be a rigid material when attached to the core by means of thread.

It is preferred in most embodiments, as shown in 317, that the core 318 and attachment loop 319 are crafted as an integral unit via an injection molding process. Any number of materials can be used for the core. For example, a recyclable thermoplastic elastomer can be used for the core. The core can also be a synthetic polymer foam. Further, the foam can be protected by a coating, such as Kevlar.

In 320, an optional line orientation device 321 is added to the molded fly body while tying the fly. The line orientation device 321 includes a loop, which may be circular or any other shape. In this figure, it is formed from a piece of polymeric monofilament tied to the core 318 of the fly. Other materials can be used. Further, the line orientation structure or device can be tied to the core 318 during fly tying. The line orientation structure can also be attached to the attachment loop and extend in any direction.

In 322 an injection molded fly body 322 incorporating all three components, attachment loop 323, core 325 and line orientation device 324 is shown and is preferred for the fly body of many streamer and dry fly patterns.

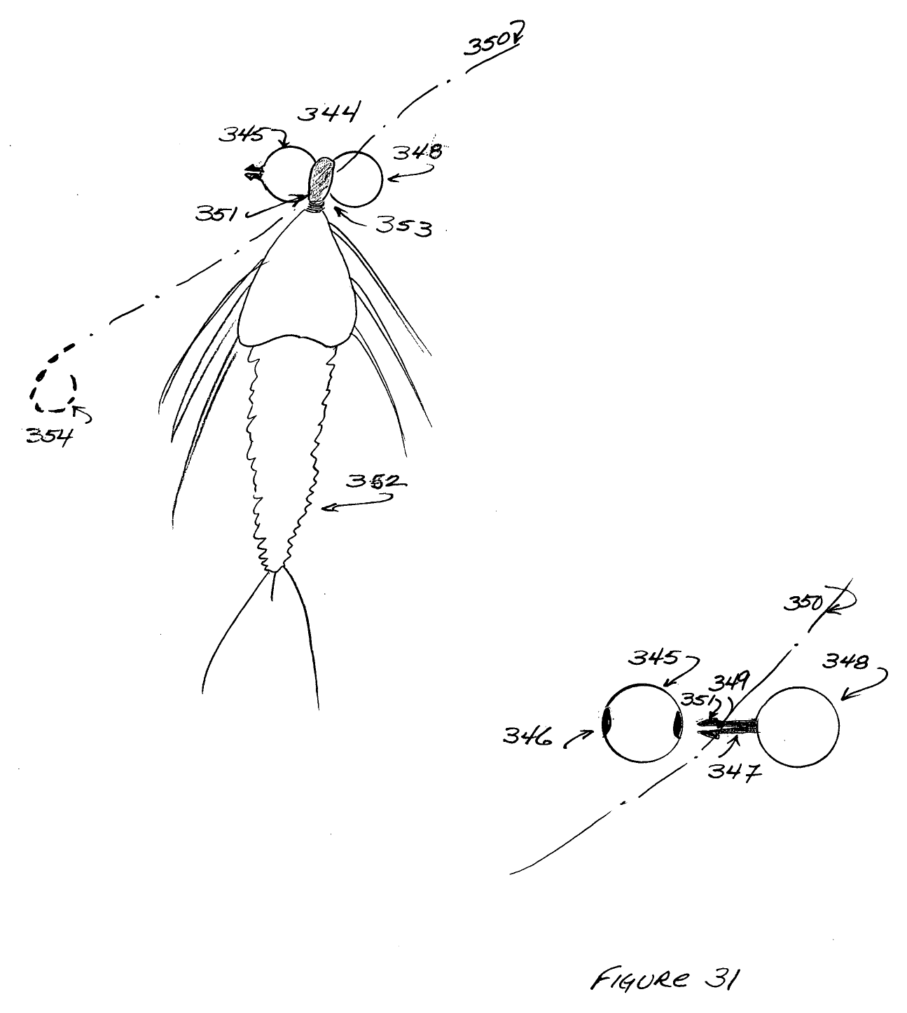

FIG. 28 exhibits a dressed fly 326 attached to the line 327 with a loop threaded through the loop attachment device 328 in the manner previously described. The hook 329 is then threaded once through the line orientation structure 330 such that the line 327 runs parallel to the long axis of the fly. This allows the fly 326 to be oriented relative to the line 327. It is preferred that the hook 329 be threaded through the line orientation structure 330 once, but it can be threaded through more than once.

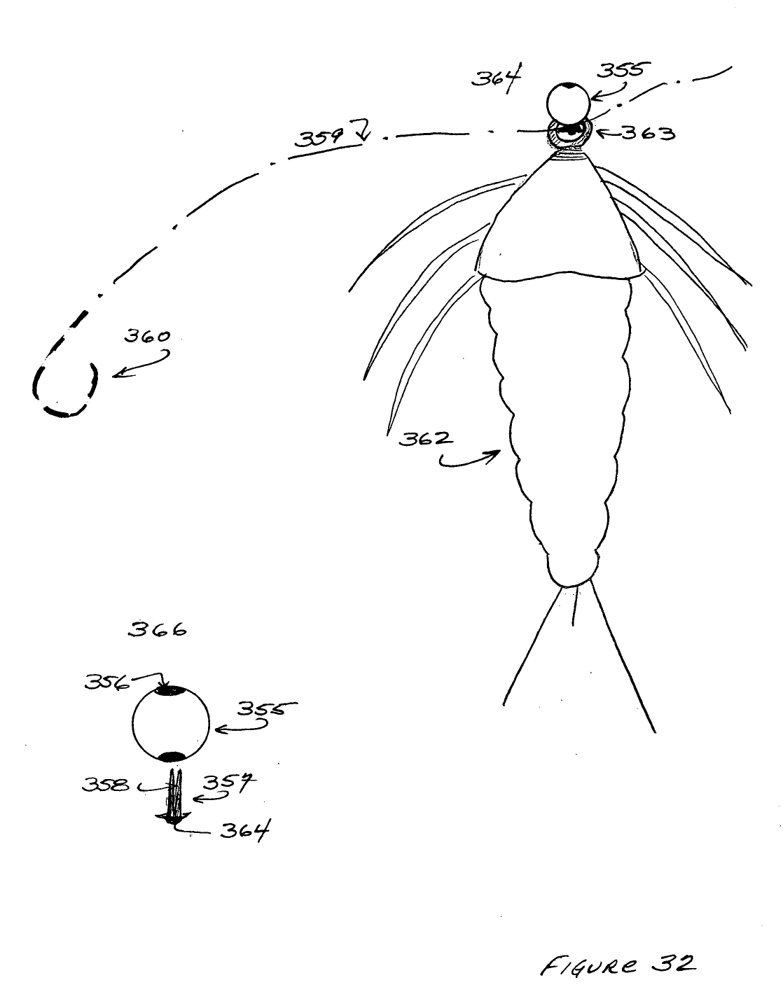

FIG. 29 demonstrates the preferred connection of the C or circle hook 331 to the line 332. The line enters the hook eye 333 from the hook's point side 334 and is attached to the hook shank 335 by any one of number of knots 336 familiar to fly fishing including the snell, uni and turle knot.

FIG. 30 demonstrates an alternate connection method 337 that utilizes a stop device 338 affixed to the line 339 at a distance above the hook 340. A hook-less fly 342 has its integral elastic attachment loop 341 threaded over the point of the hook 340 and drawn up the line 339. The elastic attachment loop 341 has been stretched over the stop device 328 in 343. The elastic material used in the attachment loop 341, no longer under pressure, rebounds to its original size preventing the hook-less fly 342 from sliding in the direction of the hook 340. A fly so rigged will stay above the stop device while fishing but may be moved by hand.

FIG. 31 shows a line attachment device consisting of paired male and female halves in 344. The female side 345 contains a cavity 346 capable of fitting to the plug 347 of the male half 348. The plug has a lengthwise split 349 through which the line 350 is threaded. The plug 347 may be fitted with prong devices 351 that exit the female cavity 346 when mated, aiding in joining the two sides. The male half 348 and female half 345 when joined together captures the line 350 between the two sides holding the attachment device in place on the line 350.

A hook-less fly 352 can have its integral elastic attachment loop 351 stretched over either the male half 348 or the female half 345 as shown in 344 and when relaxed the attachment loop 351 becomes fixed to the gap 353 between the male and female halves given the attachment loop's 351 inside diameter is smaller than either the male 345 or female half 348. The hook-less fly 352 can therefore be affixed to the line attachment device 344 without the need to thread the hook 354 through the attachment loop 351. The line attachment device 351 can take any shape such that it represents an anatomical feature of the fly being used allows the two halves to be mated together as described herein.

FIG. 32 describes a line attachment device in 366 with a beadlike female structure 355 incorporating a cavity 356 capable of accepting a plug 357 with a lengthwise split 358 to capture the line 359 and affixing the line attachment device 364 at a distance above the hook 360. Shown in drawing 365. The plug 357 may have an external fitting 361 that allows the plug to be removed when desired. The line attachment device 364 may take any shape needed to represent an anatomical feature. A fly 362 can be attached to the line attachment device 364 by pushing on the elastic attachment loop 363 and expanding the opening in the loop 363 such that it slips over the bead-like structure 355 and is captured when rebounding to its resting size that is now smaller than the diameter of the bead-like structure 355. The fly 362 is therefore attached between the larger diameter of the bead-like device 364 and the attached line 359. The fly 362 may be easily removed by pulling the fly off the attachment device 364 by hand. Additionally, the entire rig consisting of fly 362 and line attachment device 364 may be separated from the line 367 by pulling on the external fitting 361 and removing the plug 357.

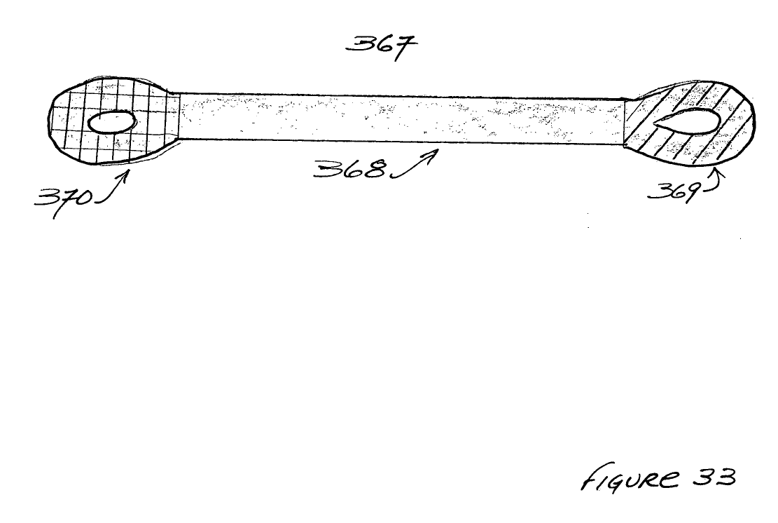

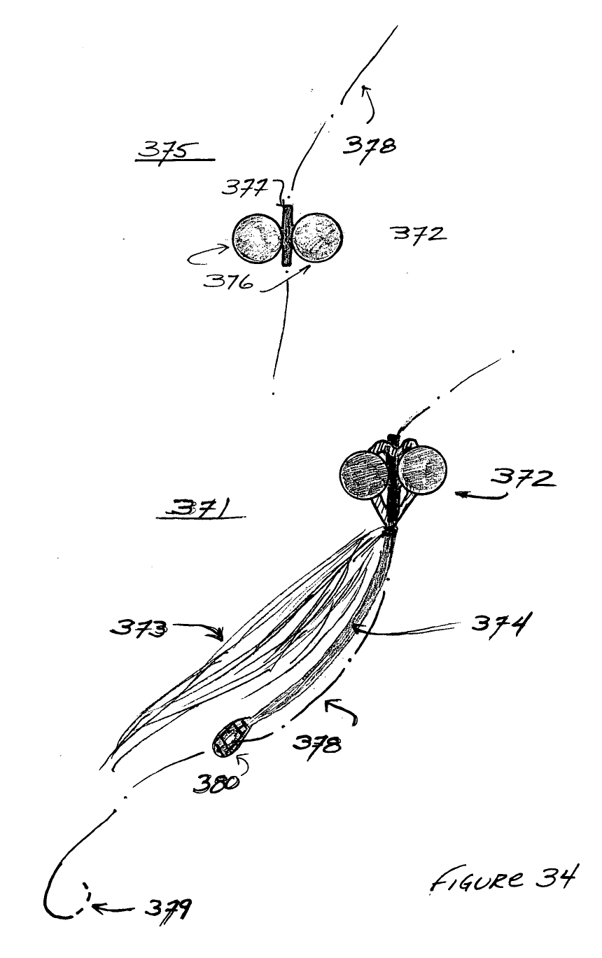

FIG. 33 shows a fly body 367 to be used when fishing for species, such as pike or bluefish, capable of biting through the fly. The fly body 367 has a core 368 of highly abrasion resistant material or an elastic core covered with an abrasion resistant synthetic material such as a hollow Kevlar braid. The attachment loop 369 may be crafted from a highly abrasion resistant material such as Kevlar in a mono or multifilament form. The attachment loop 369 may additionally be crafted of a shape memory alloy such as Nitinol. A fly being constructed in this manner would incorporate a line orientation device 370 that may be made of various wires or other abrasion resistant material. The components of the fly body 367 including the core 368, attachment loop 369 and line orientation structure 370 may be crafted separately and assembled during the fly tying process or pre-manufactured as an integral unit.

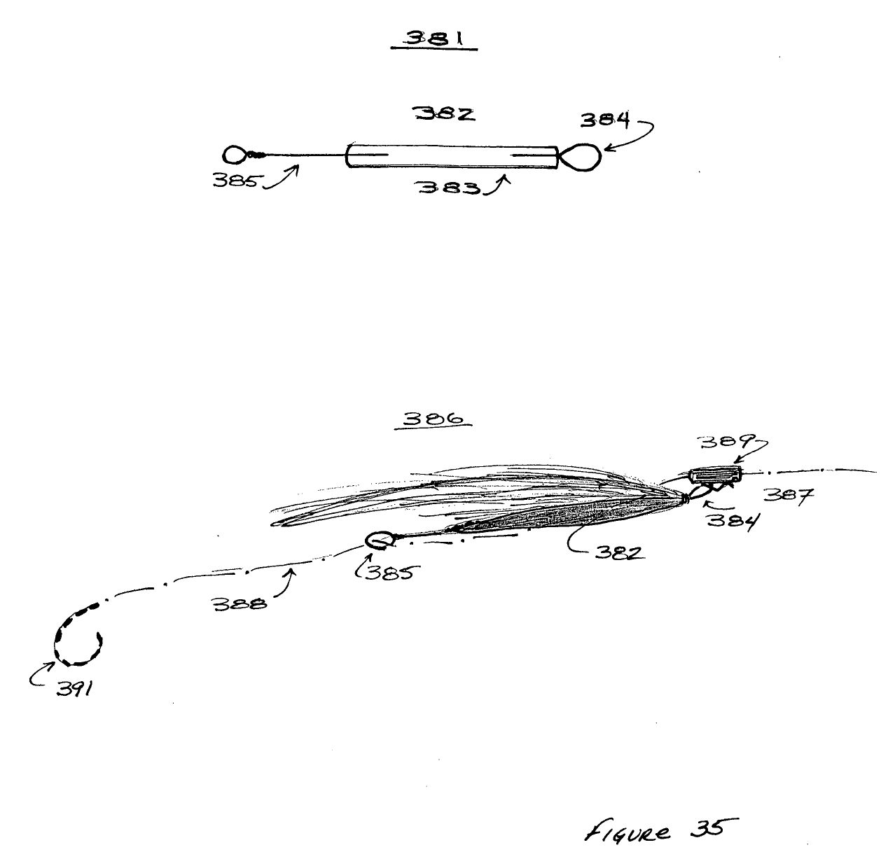

FIG. 34 shows in 371 a line attachment device 372 for a fly 373 tied on a fly body 374 as described in FIG. 31. The line attachment device 372 in 375 incorporates two spherical matching halves 376 joined to a fitting 377 slightly longer in length than the diameter of the spherical halves 376. The fitting 377 may be crimped, glued, knotted, held by compression or looped to the line 378. A fly 373 incorporating the fly body 374 is looped over the device 372 and held in place by a tortuous path. The hook 379 is threaded once through the line orientation structure 380 keeping the line 378 parallel to the long axis of the fly 373.

FIG. 35 shows in 381 an additional embodiment of a fly body 382 for use with fish such as pike and bluefish and further described in FIG. 33 above. The fly body 382 contains an abrasion resistant core 383 with an attachment loop 384 made from a shape memory alloy such as Nitinol. The line orientation structure 385 can be made of any abrasion resistant material including Nitinol. In 386, a line attachment device 387 is fixed to the line 388 by means of crimping, glues, knots or tortuous path methods. The attachment device 387 contains a clip 389. A fly 390 tied on the body 382 has the Nitinol attachment loop 384 is inserted into the clip 389. The hook 391 is threaded once through the line orientation structure 385.

In each of the previous descriptions, the preferred hook is a C or circle hook. The C or circle hook is preferably barb-less and has a non-offset point. Such a hook is defined as a hook with its point at a 90-degree angle to the hook's shank. It is further preferred that the circle hook should be non-offset such that the bend of the hook and hook point are parallel with the hook shank. It is also preferred that the eye of the circle hook be straight and parallel to the hook shank. The hook is preferred to have its point barb-less. The fishing line should enter the eye of the hook from the point side and knotted to the shank by an appropriate knot for this purpose such as the snell, uni, or turle knot.

U.S. patent application Ser. No. 10/194,613, entitled FISHING FLY AND METHOD OF FLY FISHING, filed on Jul. 12, 2002, is hereby incorporated by reference in its entirety into this application.

Although the invention herein has been described with reference to particular embodiments, it is to be understood that these embodiments are merely illustrative of the principles and applications of the present invention. It will be apparent to those skilled in the art that various modifications and variations can be made in the apparatus and methods of the present invention without departing from the spirit and scope of the invention. Thus, it is intended that the present invention include modifications and variations that are within the scope of the appended claims and their equivalents.

1. A fishing fly, comprising:
a core:
an attachment loop connected to a first end of the core; and
a line orientation structure connected to a second end of the core.

2. The fishing fly as claimed in claim 1, wherein the core, the attachment loop and line orientation structure are a single unit.

3. The fishing fly as claimed in claim 1, wherein the core and the attachment loop are a single unit.

4. The fishing fly as claimed in claim 1, wherein the core, the attachment loop and the line orientation structure are separate units.

5. The fishing fly as claimed in claim 1, wherein the line orientation structure is a loop.

6. The fishing fly as claimed in claim 1, wherein the attachment loop is elastic.

7. The fishing fly as claimed in claim 1, further comprising:
a fly line;
a hook attached to the fly line;
wherein the fishing fly is attached to the fly line at a distance from the hook.

8. The fishing fly as claimed in claim 7, wherein the hook is a circle hook.

9. The fishing fly as claimed in claim 7, wherein the hook is a non-offset circle hook.

10. The fishing fly as claimed in claim 7, further comprising a line attachment device attached between the fly line and the fishing fly.

11. The fishing fly as claimed in claim 10, wherein the line attachment device includes a male part and a female part.

12. The fishing fly as claimed in claim 11, wherein the male part is a pin that fits into a receptacle in the female part.

13. The fishing fly as claimed in claim 12, wherein the female part appears circular.

14. The fishing fly as claimed in claim 13, wherein the male part appears circular.

15. The fishing fly as claimed in claim 10, wherein the line attachment device includes a clip that receives the attachment loop.

16. The fishing fly as claimed in claim 1, further comprising dressing that is tied onto the core so that the fly represents food.

17. The fishing fly as claimed in claim 16 wherein there is no hook attached directly to the fishing fly.
